(19) United States
(12) Patent Application Publication
(10) Pub. No.: US 2016/0198306 A1
(43) Pub. Date: Jul. 7, 2016

(54) Systems And Methods For Providing Vehicle And Equipment Suggestions Using A Mobile Device

(71) Applicant: STATE FARM MUTUAL AUTOMOBILE INSURANCE COMPANY, BLOOMINGTON, IL (US)

(72) Inventors: Melissa Miles, Mesa, AZ (US); John Nepomuceno, Bloomington, IL (US); Brian Fields, Normal, IL (US); Jenna Durako, Bloomington, IL (US); Jeremy Fogg, Bloomington, IL (US)

(73) Assignee: STATE FARM MUTUAL AUTOMOBILE INSURANCE COMPANY, BLOOMINGTON, IL (US)

(21) Appl. No.: 15/070,233

(22) Filed: Mar. 15, 2016

Related U.S. Application Data
(63) Continuation-in-part of application No. 14/522,038, filed on Oct. 23, 2014.
Application No. 14/522,038 is a continuation of application No. 13/172,240, filed on Jun. 29, 2011.

(51) Int. Cl. H04W 4/02; H04B 1/3822; H04W 4/00

(52) U.S. Cl. CPC H04W 4/025; H04W 4/005; H04B 1/3822

(57) ABSTRACT

A method for providing vehicle or equipment suggestions may include providing a driving performance application for installation on a mobile device and collecting driver data at a remote server. The driver data may be transmitted through the driving performance application. The server may include a processor and a memory that stores the driver data. The server may receive driving data associated with a plurality of drivers and routes, including context dependent route information. The server may compile the data with the information. The server may analyze the data to determine a suggestion for a vehicle or piece of vehicle equipment for the driver based on safety criteria. The server may generate a notice that the suggestion is available. The server may transmit the notice based upon a transmission schedule. The transmitted notice may activate the driving performance application to make the suggestion available to the driver.

### RELATED APPLICATIONS

This application is a continuation-in-part of application Ser. No. 14/522,038, filed Oct. 23, 2014, which is a continuation of application Ser. No. 13/172,240, filed Jun. 29, 2011, the contents of which are hereby incorporated by reference in their entirety.

### TECHNICAL FIELD

The present disclosure relates generally to systems and methods for providing vehicle and equipment suggestions. In some embodiments, it may include providing vehicle and equipment suggestions based on data collected related to collected driver driving habits and/or styles and relevant conditions such as traffic, weather, and/or other context. Aspects of the data collection, evaluation, and/or feedback may be provided by a mobile device, e.g., a smart phone.

### BACKGROUND

The decision to purchase a vehicle and which vehicle to purchase can be a significant decision. Specific vehicle equipment may also be difficult to select. Interactive, computer-driven systems are available to recommend vehicles and equipment based on search criteria input by the person regarding: price range, type of vehicle, make, model, year of manufacture, equipment, etc. Some organizations provide objective, test-based information regarding vehicles and vehicle equipment, but such information is typically based on stock products observed in a controlled test environment.

Systems may filter products by prompting a user to input ranges of product attributes and then providing a list of products that satisfy the input attributes. Often the system will recommend too many or too few (or in some cases, none) products. These systems do not consider information more specific to the user or the user's product use characteristics. Other systems provide recommendations based on rules. Systems may take as input information statements provided by a user regarding desirable product features and performance characteristics and translate the statements into a comprehensive set of rules. The rules typically score products based on compliance with the rules and provide a list of products to the user ranked on score. The systems do not connect user data to product recommendations. In some cases, the users are unaware or mistaken as to the appropriate attributes of a vehicle most relevant to safety, reliability, and other selection criteria.

### SUMMARY

In accordance with the teachings of the present disclosure, disadvantages and problems associated with existing systems and methods have been reduced.

According to one embodiment of the present disclosure, a method for providing vehicle or equipment suggestions may include: providing a driving performance application to a driver for installation on a mobile device; and collecting driver data at a remote server. The driver data may be transmitted by the mobile device through the driving performance application to the server. The server may include a processor and a memory that stores the driver data. The server may receive driving data associated with a plurality of drivers and routes, the driving data including context dependent route information. The server may compile the received driving data with context dependent route information. The server may analyze the compiled driving data to determine a suggestion for a vehicle or piece of vehicle equipment for the driver based on safety criteria. The server may generate a notice that the suggestion is available for access by the driver. The server may transmit the notice to the mobile device based upon a transmission schedule. The transmitted notice may activate the driving performance application to make the suggestion available to the driver.

In another embodiment, a system for providing vehicle or equipment suggestions may include: one or more sensors associated with a motor vehicle; a mobile device in communication with the one or more sensors and equipped to communicate wirelessly with a remote server. The one or more sensors may be configured to collect driving data during a data collection session. The mobile device may run a driving performance application. The remote server may include a processor and a memory that stores a set of computer readable instructions stored in the memory. When executed by the processor the instructions may: calculate one or more metrics related to the driver's driving behavior, based at least on the collected driving data; compile the one or more calculated metrics related to the driver's driving behavior with a plurality of calculated metrics related to other drivers' driving behavior; analyze the compiled calculated metrics to determine a suggested vehicle or piece of vehicle equipment based on safety criteria; and transmit the suggestion to the driving performance application for display using the mobile device.

In another embodiment, a non-transitory computer readable medium with computer executable instructions stored thereon executed by a processor may perform a method for providing a suggested vehicle or piece of vehicle equipment. The method may include: collecting driver information associated with a driver through a mobile device interface; using one or more sensors associated with a vehicle to collect driving data during a data collection session; sending the collected driver information and the sensed driving data to a server wirelessly; and receiving a suggested vehicle or piece of vehicle equipment from the server.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a drawing that illustrates an example mobile device located in a vehicle, the mobile device supporting a driving performance system according to teachings of the present disclosure;

FIG. 2 is a schematic illustrating a network that may support a driving performance system according to teachings of the present disclosure;

FIG. 3 is a block diagram that illustrates example components of the mobile device relevant to the driving performance system, according to teachings of the present disclosure;

FIG. 4 is a flowchart illustrating an example method for providing a suggestion for a vehicle or a piece of vehicle equipment, according to teachings of the present disclosure;

FIGS. 5A-5E illustrate example screen shots generated by a driving performance application on an example mobile device, according to certain embodiments;

FIG. 6 is a flowchart illustrating an example method for providing a suggestion for a vehicle or a piece of vehicle equipment; and

FIG. 7 is a schematic drawing illustrating an example system which may be used to implement teachings of the present disclosure.

### DETAILED DESCRIPTION

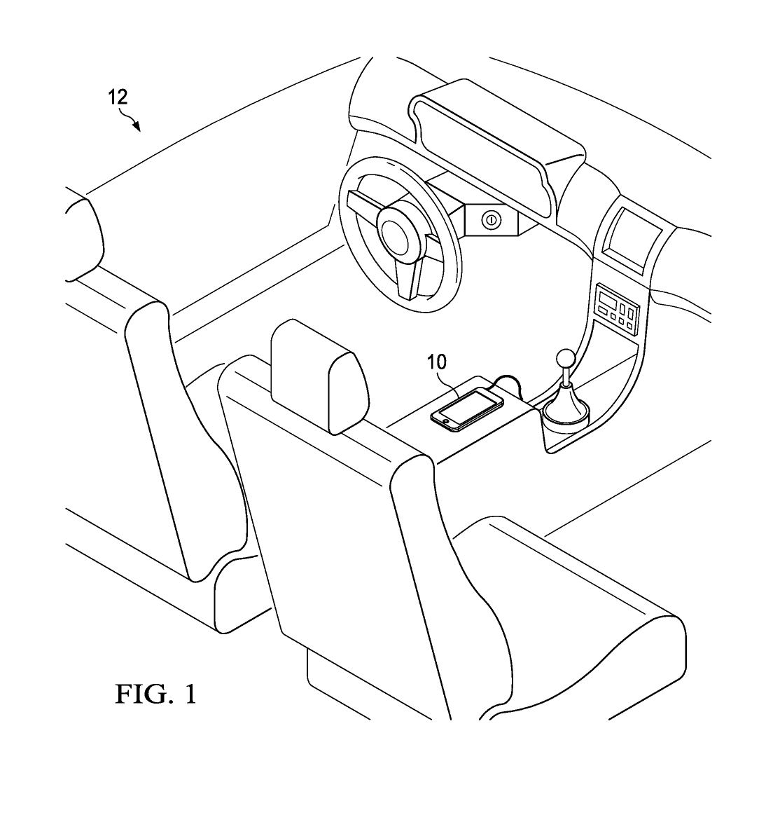

Preferred embodiments and their advantages over the prior art are best understood by reference to FIGS. 1-8 below. The present disclosure may be more easily understood in the context of a high level description of certain embodiments.

Drivers may consider a wide variety of information when deciding to purchase new or used motor vehicles. Examples may include style or visual appearance, speed and acceleration, handling performance, mechanical reliability, cost, and/or safety concerns. In many cases, this information may be anecdotal and/or limited to reputation and/or first impressions. Improvements in information technology support so-called “crowd sourced” data gathering. For example, various applications for mobile computing devices collect input from a large number of users and these data are used to provide up-to-date traffic and weather data to subscribers or users of the apps.

Teachings of the present disclosure may be used to provide crowd sourced data related to vehicle performance, reliability, and/or safety. For example, one or more drivers may provide driving performance data associated with identified vehicles. In some embodiments, the driving performance data may be collected by an application or “app” running on a smart phone, tablet computer, or any mobile computing device. The app may send the collected data to a server for processing. The server may compile driving performance data for a wide variety of drivers, vehicles, driving conditions, etc.

Upon request from the app or user, and/or as programmed, the server may generate a recommendation for the particular driver/user for a make and model of vehicle, and/or one or more specific pieces of vehicle equipment. For example, the app may provide a user with an input to prompt a recommended tire type, rating, brand, model, etc. The server may consider any number of factors, including driving performance data over routes most commonly driven by the driver, the type of vehicle driven, etc. More specific embodiments and other examples are described in relation to the FIGURES below.

FIG. 1 is a drawing illustrating an example mobile device 10 located in a vehicle 12, according to certain embodiments or implementations of the present disclosure. Mobile device 10 may comprise any type of portable or mobile electronics device, such as for example a mobile telephone, personal digital assistant (PDA), laptop computer, tablet-style computer such as the iPad by Apple Inc., or any other portable electronic device. For example, in some embodiments, mobile device 10 may be a smart phone, such as an iPhone by Apple Inc., a Blackberry phone by RIM, a Palm phone, or a phone using an Android, Microsoft, or Symbian operating system (OS), for example. Mobile device 10 may include one or more components providing wireless connection to the Internet and/or other wireless communications.

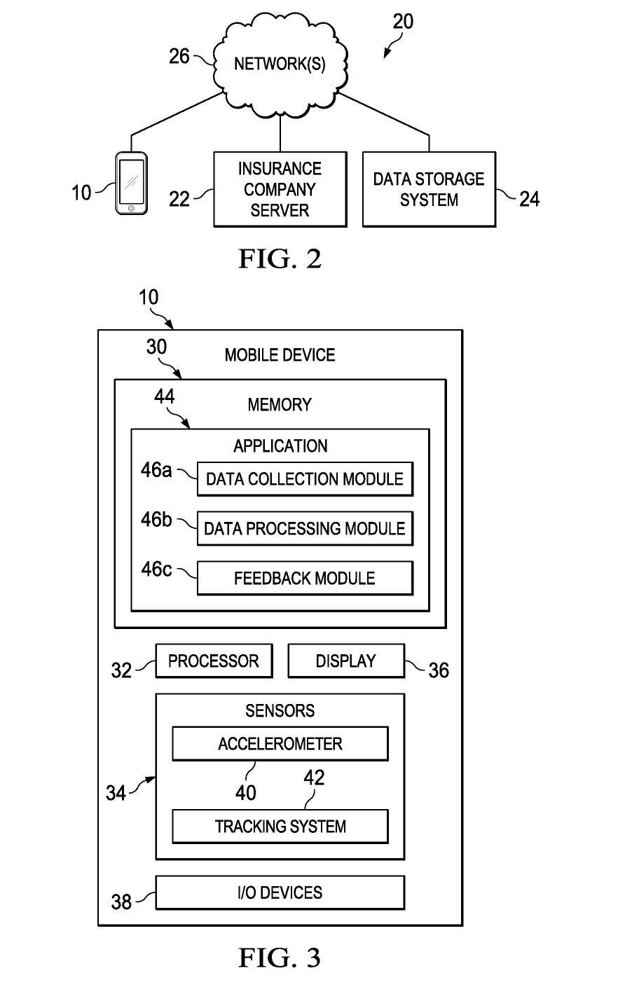

FIG. 2 is a drawing illustrating an example system 20 for sharing driving data between a mobile device 10 and other external systems or devices, according to certain embodiments. As shown, mobile device 10 may be communicatively connected to one or more remote servers 22 and/or remote data storage systems 24 via one or more networks 26.

Servers 22 may include any one or more devices operable to receive driving data from mobile device 10 and further process and/or display such data, e.g., mobile telephones, personal digital assistants (PDA), laptop computers, desktop computers, or any other device. In some embodiments, a server 22 may include any suitable application(s) for interfacing with mobile device 10, e.g., providing application(s) to be downloaded via the Internet or otherwise installed on mobile device 10.

Remote data storage devices 24 may include any one or more data storage devices for storing driving data received from mobile device 10 and/or servers 22. Remote data storage 24 may comprise any one or more devices suitable for storing electronic data, e.g., RAM, DRAM, ROM, flash memory, and/or any other type of volatile or non-volatile memory or storage device. A remote data storage device 24 may include any suitable application(s) for interfacing with mobile device 10 and/or with relevant applications running on servers 22.

Network(s) 26 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data) via any one or more wired and/or wireless communication links.

FIG. 3 is a drawing illustrating example components of mobile device 10 for use with the teachings of the present disclosure. As shown, mobile device 10 may include a memory 30, processor 32, one or more sensors 34, a display 36, and input/output devices 38.

Memory 30 may store various applications to run or executed by processor 32. Memory 30 may comprise any one or more devices suitable for storing electronic data, e.g., RAM, DRAM, ROM, internal flash memory, external flash memory cards (e.g., Multi Media Card (MMC), Reduced-Size MMC (RS-MMC), Secure Digital (SD), MiniSD, MicroSD, Compact Flash, Ultra Compact Flash, Sony Memory Stick, etc.), SIM memory, and/or any other type of volatile or non-volatile memory or storage device.

Memory 30 may store various applications 44 which, when executed, direct the actions of processor 32. An application 44 may be described in terms of functional modules 46, each embodied in a set of logic instructions (e.g., software code). For example, as shown in FIG. 3, application 44 may include a data collection module 46a, a data processing module 46b, and a feedback module 46c.

Processor 32 may include a microprocessor, a microcontroller, a digital signal processor (DSP), an application specific integrated controller (ASIC), electrically-programmable read-only memory (EPROM), or a field-programmable gate array (FPGA), or any other suitable processor(s), and may be generally operable to execute various applications, as well as supporting any other functions of mobile device 10.

Sensors 34 may include any one or more devices for detecting information regarding a driver's driving behavior and/or the driving environment. For example, sensors 34 may include an accelerometer 40 configured to detect acceleration of the mobile device 10 (and thus, the acceleration of a vehicle 12 in which mobile device 10 is located) in one or more directions (e.g., the x, y, and z directions). As another example, mobile device 10 may include a location tracking system 42, such as a GPS tracking system or any other system or device for tracking the geographic location of the mobile device. A solid state compass, with two or three magnetic field sensors, may provide data to a microprocessor to calculate direction using trigonometry. The mobile device 10 may also include proximity sensors, a camera or ambient light. As another example, mobile device 10 may include sensors, systems, or applications for collecting data regarding the driving environment, e.g., traffic congestion, weather conditions, roadway conditions, or driving infrastructure data. In addition or alternatively, mobile device 10 may collect certain driving data (e.g., driving behavior data and/or driving environment data) from sensors and/or devices external to mobile device 10 (e.g., speed sensors, blind spot information sensors, seat belt sensors, GPS device, etc.).

Any or all of this driving data collected by mobile device 10 and/or data received at mobile device 10 from external sources may be used as input to calculate one or more driving behavior metrics and/or scores based on such collected driving data. For example, a driving analysis application stored on and executed by mobile device 10 may calculate acceleration, braking, and cornering metrics based on driving behavior data collected by the built-in accelerometer (and/or other collected data). In some embodiments, a data collection application executed by mobile device 10 may send the collected driving data to a remote server 22 for analysis by server 22 running a driving analysis application.

The driving analysis application, whether executed by mobile device 10, server 22, or any other processing resource, may further calculate scores based on such calculated metrics, e.g., an overall driving score. As another example, the driving analysis application may identify “notable driving events,” such as instances of notable acceleration, braking, and/or cornering, as well as the severity of such events. In some embodiments, the driving analysis application may account for environmental factors, based on collected driving environment data corresponding to the analyzed driving session(s). For example, the identification of notable driving events may depend in part on environmental conditions such as the weather, traffic conditions, road conditions, etc. Thus, for instance, a particular level of braking may be identified as a notable driving event in the rain, but not in dry conditions.

Display 36 may comprise any type of display device for displaying information related to a user, such as for example, an LCD screen (e.g., thin film transistor (TFT) LCD or super twisted nematic (STN) LCD), an organic light-emitting diode (OLED) display, or any other suitable type of display. In some embodiments, display 36 may be an interactive display (e.g., a touch screen) that allows a user to interact with applications running on processor 32. In other embodiments, display 36 may be strictly a display device, such that all user input is received via other input/output devices 38.

Input/output devices 38 may include any suitable interfaces allowing a user to interact with mobile device 10, and in particular. For example, input/output devices 38 may include a touchscreen, physical buttons, sliders, switches, data ports, keyboard, mouse, voice activated interfaces, or any other suitable devices.

Application 44 and/or any related, required, or useful applications, plug-ins, readers, viewers, updates, patches, or other code for executing application 44 may be downloaded via the Internet or installed on mobile device 10 in any other known manner.

In some embodiments, mobile device 10 may store and execute a driving analysis application. The driving analysis application may display processed data or calculated values, e.g., driving behavior metrics and/or driving scores. In embodiments in which mobile device 10 includes a GPS or other geographic location tracking device, the application may also display a map showing the route of a trip, and indicating the location of each notable driving event. The application may also display tips to help drivers improve their driving behavior.

The driving analysis application may display some or all of such data on the mobile device 10 itself. In addition or alternatively, the driving analysis application may communicate some or all of such data via a network or other communication link for display by one or more other computer devices (e.g., smart phones, personal computers, etc.). Thus, for example, a parent or driving instructor may monitor the driving behavior of a teen or student driver without having to access the mobile device 10. As another example, an insurance company may access driving behavior data collected/processed by mobile device 10 and use such data for risk analysis of a driver and/or a specific route or section of roadway.

As discussed above, driving analysis application 44 may be stored in memory 30. Driving analysis application 44 may be described in terms of functional modules, each embodied in a set of logic instructions (e.g., software code). For example, as shown in FIG. 3, a driving analysis application 44 may include a data collection module 46a, data processing module 46b, and feedback module 46c.

Data collection module 46a may be operable to manage the collection of driving data, including driving behavior data and/or the driving environment data. Data collection module 46a may collect such data from any number and types of data sources, including (a) data sources provided by mobile device 10 (e.g., sensors 34), (b) data sources in vehicle 12 but external to mobile device 10 (e.g., on-board vehicle computer, seat belt sensors, GPS system, etc.), and/or (c) data sources external to vehicle 12 (e.g., data sources accessible to mobile device 100 by a satellite network or other telecommunication links). In certain embodiments, mobile device 10 may communicate with data source in vehicle 12 but external to mobile device 10 via a hardwire connection, Bluetooth® or other wireless means, optical signal transmission, or any other known manner. Sources in vehicle 12 but extended to mobile device 10 may include: engine RPM, speedometer, fuel usage rate, exhaust components or other combination indications, suspension system monitors, seat belt use indicators, tracking systems for other vehicles in vicinity, blind spot indicators.

Data collection module 46a may collect data over one or more data collection sessions corresponding to one or more driving sessions. As used herein, a “driving session” may refer to any period of driving, which may comprise a single uninterrupted trip, a portion of a trip, or a series of multiple distinct trips. A “data collection session” may generally correspond to one driving session, a portion of a driving session, or multiple distinct driving sessions. Further, a data collection session may comprise an uninterrupted period of data collection or may include one or more interruptions (e.g., in some embodiments, if mobile device 10 is moved out of proper orientation for data collection). Thus, in some embodiments, each interruption of data collection initiates a new data collection session; in other embodiments, e.g., where a data collection session generally corresponds to a driving trip, an interrupted data collection session may reconvene after the interruption.

Any or all data collected by data collection module 46a may be time stamped (e.g., time and date), either by data collection module 46a itself or by another device that collected or processed particular data before sending the data to data collection module 46a. The time stamping may allow for data from different sources (e.g., data from accelerometer 40, location tracking system 42, a seat belt sensor, etc.) to be synchronized for analyzing the different data together as a whole (e.g., to provide the driving context for a particular reading of accelerometer 40).

In some embodiments, data collection module 46a may collect data corresponding to physical parameters or characteristics of vehicle 12 (e.g., type of vehicle, type of tires, condition of tires, etc.). In some embodiments, data collection module 46a may collect data related to specific drivers of vehicle 12. Driver data may include various information related to driver experience, number of passengers in vehicle 12, and/or any sort of data that might provide context for the specific driving data collected for a particular data collection session. In some embodiments, server 22 may be an insurance company server and may have access to driver data associated with one or more motor vehicle insurance policies issued by the insurance company to the driver.

Data processing module 46b may be operable to process or analyze any of the driving data (e.g., driving behavior data and/or the driving environment data) collected by mobile device 10 itself and/or collected by external devices and communicated to mobile device 10, and based on such collected driving data, calculate one or more driving behavior metrics and/or scores. For example, data processing module 46b may calculate the driving behavior metrics of acceleration, braking, and/or cornering metrics based on driving behavior data collected by an accelerometer 40, location tracking system 42, and/or other collected data. Further, data processing module 46b may calculate one or more driving scores based on the calculated driving behavior metrics (e.g., acceleration, braking, cornering, etc.) and/or based on additional collected data. For example, data processing module 46b may apply algorithms that calculate a driving score based on weighted values for each respective driving behavior metric, and environmental correction values based on the relevant driving environment data, such as weather, traffic conditions, road conditions, etc.

Data processing module 46b may calculate individual driving behavior metrics (e.g., acceleration, braking, cornering, etc.) and/or driving scores for individual data collection sessions. Similarly, data processing module 46b may calculate driving behavior metrics and/or driving scores corresponding to a group of data collection sessions, which may be referred to as group-session metrics/scores. Data processing module 46b may calculate group-session metrics/scores may using averaging, filtering, weighting, and/or any other suitable algorithms for determining representative metrics/scores corresponding to a group of data collection sessions. A “group” of data collection sessions may be specified in any suitable manner, for example:
The n most recent data collection sessions;
The n most recent data collection sessions corresponding to one or more specific driving conditions or other preset conditions, such as for example: nighttime driving, daytime driving, driving within specific times of day (e.g., specific hours), weekend driving, weekday driving, highway driving, city driving, rush-hour driving, good-weather driving, bad-weather driving, driving in specific weather conditions (e.g., rain, snow, etc.), trips of specified distances (e.g., trips shorter than a threshold distance, longer than a threshold distance, or within any present range of distances, trips associated with a certain geographic area (e.g., trips within or near a specific city), trips between specific points (e.g., trips between the driver's home and work, which may be determined for example by GPS data or entered into application 44 by the driver), trips following a specific route (e.g., which may be determined for example by GPS data or entered into application 44 by the driver), driving alone (e.g., which status may be entered into application 44 by the driver), driving with passengers (e.g., which status may be entered into application 50 by the driver),
All data collection sessions within a specified time period, e.g., all data collection sessions in the last day, week, 30 days, 90 days, year, or any other specified time period.
All data collection sessions within a specified time period that also correspond to one or more specific driving conditions or other preset conditions, e.g., any of the conditions listed above.
All data collection sessions within a specified time period that also correspond to one or more specific driving conditions or other preset conditions, e.g., any of the conditions listed above.
Any combination or variation of any of the above.
   The number n may be any multiple number (2, 3, 4, 5, etc.), which may be automatically determined by application 44, selected by a user, or otherwise determined or selected.

Further, as mentioned briefly above, data processing module 46b may identify “notable driving events,” such as instances of notable acceleration, braking, and cornering, as well as the severity of such events. Data processing module 46b may identify notable driving events using any suitable algorithms. For example, an algorithm may compare acceleration data from accelerometer 40 (raw or filtered) to one or more predefined thresholds for notable acceleration, braking, or cornering. In some embodiments, data processing module 46b may analyze the acceleration data in combination with contextual data, which may provide a context for the acceleration data, and analyze the acceleration data based on the context data. Thus, for example, particular acceleration data may or may not indicate “notable acceleration” depending on the contextual data corresponding (e.g., based on time stamp data) to the particular acceleration data being analyzed. Data processing module 46b may utilize algorithms that analyze the acceleration data together with the relevant contextual data.

Contextual data may include, for example, location data and/or driving environment data. Module 46b may use location data (e.g., from location tracking system 42) in this context to determine the type of road the vehicle is travelling on, the speed limit, the location of the vehicle relative to intersections, traffic signs/light (e.g., stop signs, yield signs, traffic lights), school zones, the location of railroad tracks, traffic density, and/or any other features or aspects accessible from location tracking system 42 that may influence driving behavior. Module 46b may use driving environment data in this context to determine, for example, the relevant weather, traffic conditions, road conditions, etc. Based on driver and/or vehicle information gathered by driving performance application 44, the contextual data may include a vehicle type and/or specific vehicle equipment used for the driving session.

In some embodiments, data processing module 46b may apply different thresholds for determining certain notable driving events. For example, for determining instances of “notable cornering” based on acceleration data from accelerometer 40 and weather condition data (e.g., from sensors on the vehicle, sensors on mobile device 10, data from an online weather application (e.g., www.weather.com), or any other suitable source), module 46b may apply different thresholds for identifying notable cornering in dry weather conditions, rainy weather conditions, and icy weather conditions. As another example, for determining instances of “notable braking” based on acceleration data from accelerometer 40 and location data (e.g., from a GPS system), module 46b may apply different thresholds for identifying notable braking for highway driving, non-highway driving, low-traffic driving, high-traffic driving, approaching a stop sign intersection, approaching a stop light intersection, etc.

Further, in some embodiments, data processing module 46b may define multiple levels of severity for each type (or certain types) of notable driving events. For example, module 46b may define the following levels of notable braking: (1) significant braking, and (2) extreme braking. As another example, module 46b may define the following three progressively severe levels of particular notable driving events: (1) caution, (2) warning, and (3) extreme. Each level of severity may have corresponding thresholds, such that the algorithms applied by module 46b may determine (a) whether a notable event (e.g., notable braking event) has occurred, and (b) if so, the severity level of the event. Each type of notable driving event may have any number of severity levels (e.g., 1, 2, 3, or more).

In some embodiments, data processing module 46b may calculate the number of each type of notable driving events (and/or the number of each severity level of each type of notable driving event) for a particular time period, for individual data collection sessions, or for a group of data collection sessions (e.g., using any of the data collection session “groups” discussed above).

In some embodiments, either server 22 or data processing module 46b may process the collected driving data to determine one or more metrics for a particular driving segment. For example, data processing module 46b may calculate a one-second moving average of the G-force. Thus, if the data collection is for instance 5 Hz, the 5-step moving average may be calculated.

The “jerk” at each time stamp Tᵢ, wherein jerk at a particular time stamp T is defined as follows:
Jerk=abs (moving averaged G-force at time stamp Tⱼ−moving averaged G-force at time stamp Tⱼ₋₁)/unit_time (1 second)
   (Alternatively, jerk may be calculated using raw G-forces data instead of averaged G-force data.)

Module 46b may then calculate the one-second moving average of the jerk.

Module 46b may then determine one or more driving behavior metrics based on the moving averaged jerk and G-force data. For example, module 46b may determine a G-force percentile and a jerk percentile at each time stamp Tᵢ by accessing look-up tables corresponding to one or more relevant parameters. For instance, a portion of an example look-up table for an example set of relevant parameters is provided below:
Relevant Parameters:
   Vehicle: Impala
   Vehicle type: Sedan
   Acceleration direction (lateral or longitudinal): Lateral
   Type of data (G-force or Jerk): G-force
   Speed range: 0-100 mph

TABLE 1
G-force Percentile Look-Up Table

| | |
|---|---|
| G-force range | Percentile |

| | | |
|---|---|---|
| 0.000 | 0.012 | 0 |
| 0.013 | 0.025 | 1 |
| 0.026 | 0.038 | 2 |
| 0.039 | 0.051 | 3 |
| 0.052 | 0.064 | 4 |
| 0.065 | 0.077 | 5 |
| 0.078 | 0.090 | 6 |

Module 46b may store or have access to any number of such look-up tables for various combinations of relevant parameters. For example, module 46b may store a look-up table (similar to Table 1) for determining the jerk percentile. As another example, module 46b may store similar look-up tables for determining G-force and jerk percentiles for different combinations of vehicles, vehicle types, speed ranges, acceleration direction (lateral or longitudinal), etc.

Data processing module 46b may calculate a Base Driving Score for the data collection session, according to the following equation:

Base Driving Score=(AVG_G−force_percentile)*W1+(AVG_Jerk_percentile)*W2

wherein:
AVG_G-force_percentile is the average of the G-force percentiles for all time stamps Tᵢ during the data collection session;
AVG_Jerk_percentile is the average of the jerk percentiles for all time stamps Tᵢ during the data collection session; and
W1 and W2 are weighting constants used to weight the relative significance of G-force data and jerk data as desired.

As another example, the base driving score may be calculated according to the following equations:

Tᵢ Driving Score=min(100,250−(2*Tᵢ percentile))

Base Driving Score=average of all Tᵢ Driving Scores in which max G-force (lateral,longitudinal)<predefined minimal value.

wherein:
Tᵢ percentile is a percentile determined for each time stamp Tᵢ (e.g., G-force percentile, jerk percentile, or a weighted average of G-force percentile and jerk percentile for the time stamp Tᵢ);
Tᵢ Driving Score is a driving score for each time stamp Tᵢ; and
Tᵢ Driving Scores in which max G-force (lateral, longitudinal)<predefined minimal value indicates that data from time stamps in which the max (lateral, longitudinal) G-force is less than some predefined minimal value (e.g., 0.01) is excluded from the calculations. For example, due to the fact that g-forces may be less than some predefined minimal value (e.g., 0.01) at some or many time stamps (e.g., during highway cruise driving), as well as the issue of unstable g-force reading (below) a predefined minimal value, module 42 may ignore data from time stamps in which the max (lateral, longitudinal) G-force is less than the predefined minimal value.

Data processing module 46b may identify and analyze any notable driving events during the data collection session, based on the collected/processed G-force data and jerk data. For example, it may compare the lateral and longitudinal G-force data to corresponding threshold values to identify the occurrence of notable driving events. For example, the following example algorithms may identify the occurrence and type of a notable driving event (NDE) for a Chevrolet Impala:
lat_magnitude_gf=max(0, abs(LatG)−0.40);
lon_magnitude_gf=max(0, abs(LonG)−0.30);
magnitude_gf=max(lat_magnitude_gf, lon_magnitude_gf);
if magnitude_gf=lat_magnitude_gf and latG.>0 then NDE_type=“L”;
else if magnitude_gf=lat_magnitude_gf and latG.<=0 then NDE_type=“R”;
else if magnitude_gf=lon_magnitude_gf and lonG<0 then NDE_type=“A”;
else if magnitude_gf=lon_magnitude_gf and lonG>=0 then NDE_type=“D”;
else no NDE identified.

wherein:
LatG=lateral G-forces detected by the accelerometer;
LonG=longitudinal G-forces detected by the accelerometer;
NDE_type “L”=Left Cornering
NDE_type “R”=Right Cornering
NDE_type “A”=Acceleration
NDE_type “D”=Deceleration

The threshold values used in such algorithms (e.g., the LatG and LonG threshold values 0.40 and 0.30 shown above) may be specific to one or more parameters, to apply appropriate thresholds based on the parameter(s) relevant to the data being analyzed. For example, server 22 and/or data processing module 46b may use different threshold values for different types of vehicles. To illustrate an example, the following threshold values may be used for three different vehicles: Impala, Camaro, and Ford Van:
Impala (shown above)
   LatG threshold=0.40
   LonG threshold=0.30
Camaro
   LatG threshold=0.60
   LonG threshold=0.40
Ford Van
   LatG threshold=0.30
   LonG threshold=0.30

It should be understood that the threshold values shown above are examples only, and that any other suitable values may be used.

To determine the severity level of each notable driving event (NDE) identified during the data collection session, the following algorithm may be used (e.g., caution, warning, or extreme) of each NDE:
start the algorithm
identify the G-force magnitude peak associated with the NDE;
if the G-force magnitude peak is at least 0.2 above the relevant LatG/LonG threshold, the NDE severity level is “extreme”;
else if the G-force magnitude peak is at least 0.1 above the relevant LatG/LonG threshold, the NDE severity level is “warning”; and
else if the G-force magnitude peak is above the caution threshold, the NDE severity level is “caution”.
   It should be understood that the threshold values shown above (0.2 and 0.1) are examples only, and that any other suitable values may be used. These example algorithms may be used to determine ratings, warnings, and/or scores for individual drive segments, averages for a particular segment of roadway, for vehicle types, drivers meeting a certain demographic definition, etc.

In some embodiments, server 22 and/or driving performance application 44 may receive raw driving data, calculated driving scores, and/or context information from other applications running on mobile device 10 and/or other processors in communication with server 22 and/or mobile device 10.

Feedback module 46c may be operable to display any data associated with application 44, including raw or filtered data collected by data collection module 46a and/or any of the metrics, scores, or other data calculated or proceed by data processing module 46b. For the purposes of this description, unless otherwise specified, “displaying” data may include (a) displaying data on display device 36 of mobile device 10, (b) providing audible feedback via a speaker of mobile device 10, providing visual, audible, or other sensory feedback to the driver via another device in the vehicle (e.g., through the vehicle's radio or speakers, displayed via the dashboard, displayed on the windshield (e.g., using semi-transparent images), or using any other known techniques for providing sensory feedback to a driver of a vehicle, (d) communicating data (via a network or other wired or wireless communication link or links) for display by one or more other computer devices (e.g., smart phones, personal computers, etc.), or (e) any combination of the preceding. To provide feedback to the driver visual, audible, or other sensory feedback to the driver via a feedback device in the vehicle other than mobile device 10, mobile device 10 may include any suitable communication system for wired or wireless communication of feedback signals from mobile device 10 to such feedback device.

Further, feedback module 46c may also initiate and/or manage the storage of any data associated with application 44, including raw or filtered data collected by data collection module 46b and/or any of the metrics, scores, or other data calculated or proceed by data processing module 46b, such that the data may be subsequently accessed, e.g., for display or further processing. For example, feedback module 46c may manage short-term storage of certain data (e.g., in volatile memory of mobile device 10), and may further manage long-term storage of certain data as historical driving data (e.g., in non-volatile memory of mobile device 10). As another example, feedback module 46c may communicate data associated with application 44 via a network or other communication link(s) to one or more other computer devices, e.g., for storage in a remote data storage system 24.

Feedback module 46c may be operable to display metrics, scores, or other data in any suitable manner, e.g., as values, sliders, icons (e.g., representing different magnitudes of a particular metric/score value using different icons or using different colors or sizes of the same icon), graphs, charts, etc. Further, in embodiments in which mobile device 10 includes a GPS or other location tracking system 42, feedback module 46c may display one or more maps showing the route travelled during one or more data collection sessions or driving sessions, and indicating the location of “notable driving events.” Notable driving events may be identified on the map in any suitable manner, e.g., using representative icons. As an example only, different types of notable driving events (e.g., notable acceleration, notable braking, and notable cornering) may be represented on the map with different icons, and the severity level of each notable driving event may be indicated by the color and/or size of each respective icon.

In some embodiments, feedback module 46c may provide the driver real time feedback regarding notable driving events, via any suitable form of feedback, e.g., as listed above. For example, feedback module 46c may provide audible feedback (e.g., buzzers or other sound effects, or by human recorded or computer-automated spoken feedback) through a speaker of mobile device 10 or the vehicle's speakers, or visual feedback via display 36 of mobile device 10 or other display device of the vehicle. Such real-time audible or visual feedback may distinguish between different types of notable driving events and/or between the severity level of each notable driving event, in any suitable manner. For example, spoken feedback may indicate the type and severity of a notable driving event in real time. Non-spoken audible feedback may indicate the different types and severity of notable driving events by different sounds and/or different volume levels.

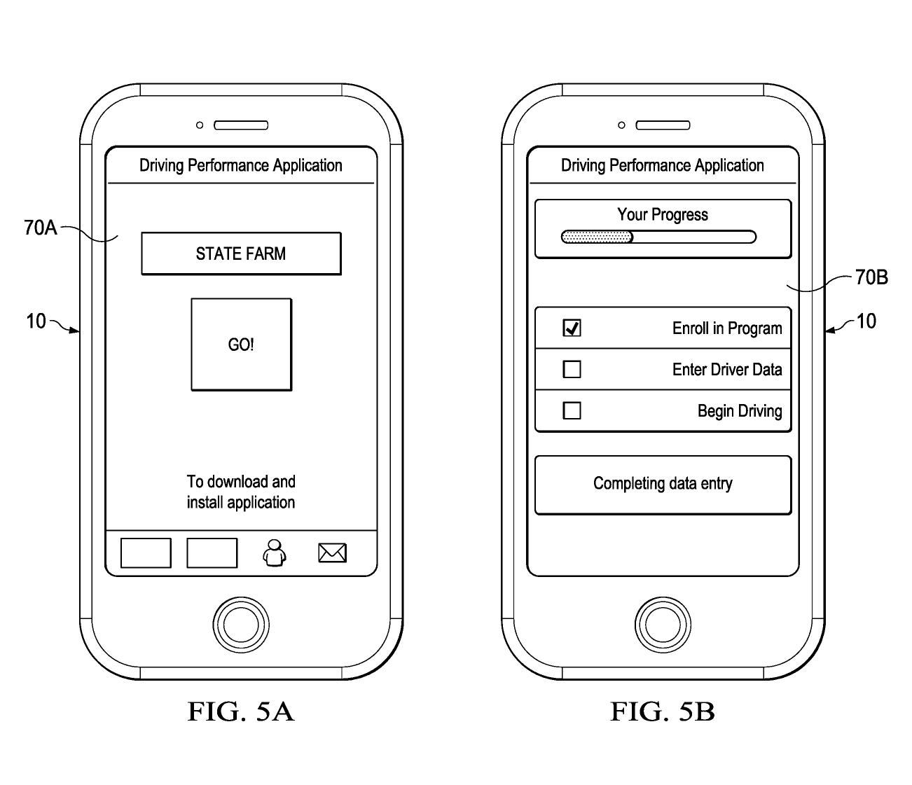

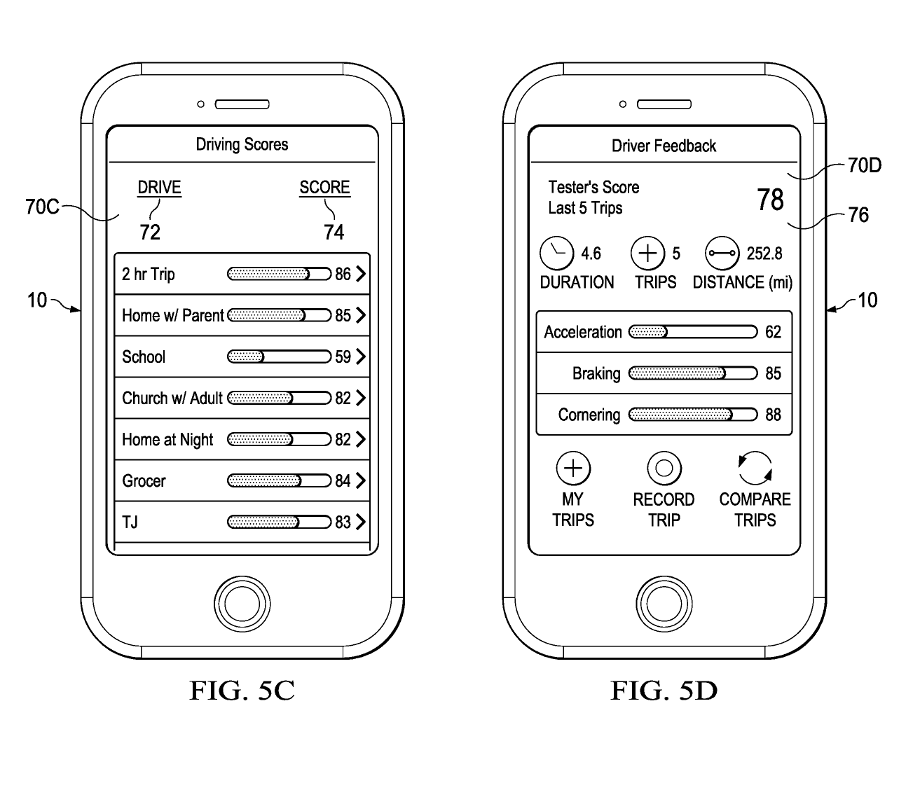

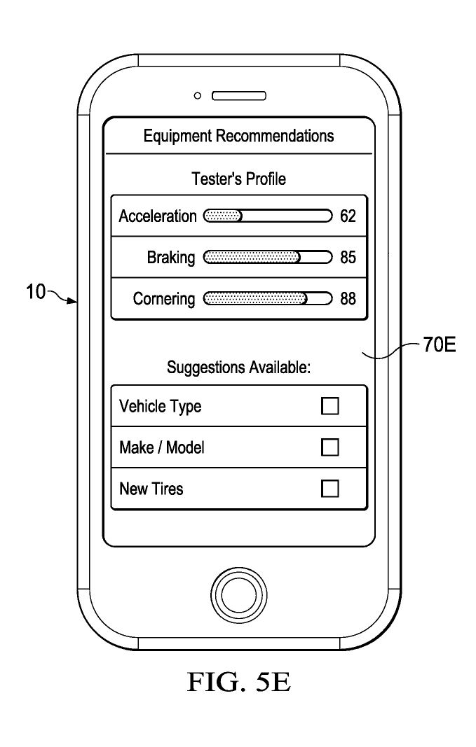

Feedback module 46c may manage user interactions with application 44 via input/output devices 38 (e.g., a touchscreen display 36, keys, buttons, and/or other user interfaces). For example, feedback module 46c may host a set or hierarchy of displayable objects (e.g., screens, windows, menus, images, etc.) and facilitate user navigation among the various objects. An example set of displayable objects, in the form of screens, is shown and discussed below with reference to FIGS. 5A-5E, described in more detail below. In some embodiments, feedback module 46c may generate a series of user-navigable screens, windows, or other objects for display on display device 36 on mobile device 10. FIGS. 5A-5E discussed below illustrate example screen shots generated by an application, according to example embodiments.

Data collection module 46a may access any environmental data applications or interfaces for collecting driving environment data regarding the driving environment corresponding to a driving data collection session. For example, environmental data applications may comprise any applications or interfaces operable to collect data from one or more sensors on vehicle 12 or from one or more devices external to vehicle 12 (via a network or communication links) regarding the relevant driving environment. For example, such driving environment data may include any of (a) traffic environment characteristics, e.g., congestion, calmness, or excitability of traffic, quantity and type of pedestrian traffic, etc., (b) weather environment characteristics, e.g., ambient temperature, precipitation, sun glare, darkness, etc., (c) roadway environment characteristics, e.g., curvature, skid resistance, elevation, gradient and material components, etc., (d) infrastructure environment characteristics, e.g., lighting, signage, type of road, quantity and type of intersections, lane merges, lane markings, quantity and timing of traffic lights, etc., and/or (e) any other type of driving environment data.

In some embodiments, data collection module 46a collects information and data sufficient to enable the data processing module 46b to analyze specific routes, roadways, and/or segments of roadways. In some embodiments, application 44 may collect information and data from the user of mobile device 10 and transmit that information to servers 22 for analysis. Server 22 may compile transmitted information and data from multiple drivers, collected by multiple mobile devices 10 over a multitude of driving sessions. In such embodiments, servers 22 may include executable commands, or an application, which analysis the compiled data to assess safety and/or other conditions for a particular stretch of roadway.

In some embodiments, mobile device 10 may execute or run a driving performance application that provides suggestions for vehicle type and/or a piece of vehicle equipment. For example, after collecting and analyzing driving performance data as described above, driving performance application 44 may determine a particular driver has one or more driving tendencies or frequent behaviors (e.g., frequent hard stops, no hard cornering, gentle acceleration, etc.). Based on the analysis of the driver's driving performance data, driving performance app 44 may recommend a certain make/model of vehicle, one or more safety features, a certain brand and/or rating of vehicle equipment, etc.

For example, driving performance app 44, alone and/or in conjunction with server 22, may determine a certain driver has a tendency to take corners at high speed. In that case, driving performance app 44 may provide a suggestion to the driver that he or she use tires with a high cornering performance rating, either by rating code, make/model, and/or any other identifying characteristic. Server 22 may compare the driver's driving performance to other drivers with similar equipment, similar driving habits, etc., to generate one or more recommendations or suggestions for a vehicle and/or a vehicle equipment.

In some embodiments, server 22 may be owned and/or operated by an insurance company. For example, the driver may request and access driving performance app 44 as provided by his or her automotive insurance policy provider. An insurance server 22 may provide suggestions based on improved safety ratings for the benefit of both the driver and the insurance company. In some embodiments, the insurance company may offer one or more insurance discounts for drivers adopting the provided suggestion.

In some embodiments, driving performance app 44 may suggest a specific make and model of vehicle. For example, if the driving performance data indicates high cornering loads, driving performance app 44 may suggest the driver avoid vehicles with a high center of gravity to reduce the risk of rollover (e.g., avoid tall vans and/or SUVs). In another example, if the driving performance data suggests that the driver brakes later than average for a stop, driving performance app 44 may recommend a vehicle or vehicle class with shorter braking distances. Persons having ordinary skill in the art will be able to generate a multitude of specific recommendations based on driving performance data relying on the teachings of the present disclosure.

Driving performance app 44 may provide the suggestions discussed above at any suitable interval. For example, in some embodiments, driving performance app 44 may run in the background and collect driving performance data over multiple driving sessions without updating or communicating suggestions. Only when mobile device 10 is in communication with a wi-fi network (as opposed to using cellular data), will driving performance app 44 communicate the accumulated data to server 22. At that point, server 22 may analyze the collected data to determine whether a new or updated suggestion is warranted. In some embodiments, driving performance app 44 may alert a user that a recommendation is available any time the user logs in or otherwise activates driving performance app 44. In some embodiments, driving performance app 44 may provide suggestions based on one or more pieces of data collected. For example, driving performance app may provide a recommendation for tire brand, type, etc. if mobile device 10 enters a tire store.

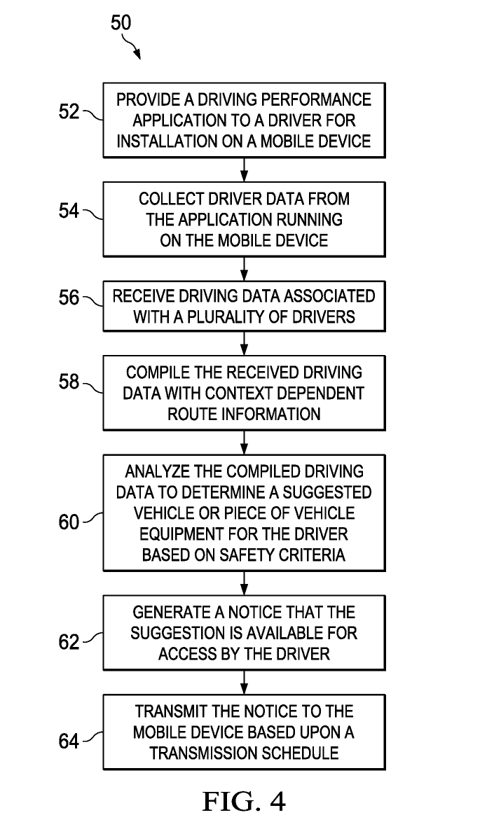

FIG. 4 is a flowchart illustrating an example method 50 for providing suggestions for a vehicle or piece of vehicle equipment, according to teachings of the present disclosure. Method 50 may be executed by a server 22 in communication with a multitude of mobile devices 10. Server 22 may include a processor and a memory that stores data.

At step 52, server 22 may provide a driving performance application to a driver for installation on a mobile device 10. Mobile device 10 may communicate with server 22 over any appropriate network, including wireless access to the Internet. The route information application may include various modules as described above.

At step 54, server 22 may collect driver data. The driver data may be transmitted by mobile device 10 through the driver performance application to server 22. As described above, the driver data may include specific information related to the driver, including driver data associated with one or more vehicle insurance policies accessible to server 22.

At step 56, server 22 may receive driving data associated with a plurality of drivers and routes. The driving data may include context dependent route information. For example, as described above, the driving data may include driver performance scores over specific driving routes along with context data including make and model of vehicle, type and/or condition of vehicle equipment, relevant time of day, weather conditions, traffic conditions, etc.

At step 58, server 22 may compile the received driving data with context dependent route information. Server 22 may use the driving data received at step 56 to assess an overall safety level for a vehicle, vehicle type, piece of vehicle equipment, etc. In some embodiments, server 22 may be configured to assess a condition-based safety level (e.g., a first safety level for novice drivers, a second safety level for experienced drivers, a third safety level for wet roads, etc.). The safety level may be assessed based on a variety of data input, including driver performance scores with associated vehicles and/or equipment, actual vehicle incident data (e.g., moving violations and/or motor vehicle accidents), etc.

At step 60, in response to a request from the driving performance application or as prompted by driving performance scores, etc., server 22 may analyze the compiled driving data to determine a suggested vehicle or piece of vehicle equipment for the driver based on safety criteria. The request for a suggestion may include a specific piece of equipment to be replaced (e.g., the driver is going to buy new tires).

Server 22 may use various criteria to determine the suggested vehicle and/or piece of vehicle equipment, including specific driver information (e.g., experience level, driving history, etc.) and/or selecting the safest combined safety level over all collected driving performance data. In some embodiments, server 22 may include driver data in its assessment, including the experience level or specific driving behaviors of the driver. Server 22 may consider the driver's most frequent driving conditions, including traffic levels, weather conditions, etc. Server 22 may consider drivers with similar driving histories and/or behaviors to the driver making the request and weigh those driving performance scores higher during the determination.

At step 62, server 22 may generate a notice identifying the suggested vehicle or piece of vehicle equipment for display to the driver. Server 22 may generate the notice based on any sort of appropriate criteria. For example, server 22 may generate the notice when sufficient data is collected to support a new recommendation. Server 22 may generate the notice based on miles of travel for the vehicle and/or for hours of driving.

At step 64, server 22 may transmit the notice to mobile device 10 based upon a transmission schedule. For example, the transmission schedule may be based on the availability of wi-fi access as opposed to using cellular data. In some embodiments, the transmission schedule may be based on events or accumulated data, such as entering an automotive repair shop, a tire store, etc. In some examples, the notice may be transmitted in response to a request from the driver using mobile device 10 and/or driving performance app 44.

At step 66, the transmitted notice may activate driving performance app 44 to make the suggestion available to the driver. In some embodiments, activating driving performance app 44 may include providing an alert, an alarm, a banner, etc. to the main display of mobile device 10.

The display of the suggestion may include a vendor locations, pricing, and/or any other relevant data for the driver. In embodiments with server 22 providing the driving performance app 44 on behalf of an insurance company, the insurance company may offer one or more rating adjustments based on whether the driver adopts the suggestion provided by driving performance app 44.

As part of the selection of a suggestion, server 22 may calculate an Adjusted Driving Score for one or more driving sessions, by considering a multitude of reported Base Driving Score based on reported NDEs. For example, server 22 may deduct from the Base Driving Score based on the number, type, and/or severity level of NDEs. In some embodiments, only certain types and/or severity levels of NDEs are deducted from the Base Driving Score. For example, server 22 may execute the following algorithm, in which only “warning” and “extreme” level NDEs (but not “caution” level NDEs) are deducted from the Base Driving Score:
NDE Penalty for each NDE=50*(G-force−G-force_warning_threshold);
Adjusted Driving Score=Base Driving Score−sum (NDE Penalties)

It should be understood that this algorithm is an example only, and that any other suitable algorithms for determining an Adjusted Driving Score may be used.

FIGS. 5A-5E illustrate example screen shots generated by driving performance application 44 on an example mobile device 10, according to certain embodiments. FIG. 5A is a drawing of an example mobile device 10 showing a display screen 70a that might be used to provide access for mobile device 10 to download a driving performance application according to teachings of the present disclosure. Screen 70a may be accessible by a web browser, an application running on mobile device 10, and/or any other appropriate avenue of communication between mobile device 10 and server 22.

FIG. 5B is a drawing of example mobile device 10 showing a display screen 70b that might be used to collect driver data according to teachings of the present disclosure. For example, once downloaded onto mobile device 10, driving performance application 44 may request various data to customize the results for the driver, to provide context for any driving data collected, to establish preferences for the user related to driving skills, experience, vehicle type, etc.

FIG. 5C illustrates an example screenshot of a screen 70c summarizing various data for each of multiple data collection sessions. In this example, screen 70c indicates for each data collection session for a particular driver: a trip description (manually entered by a user or automatically determined by module 46b, e.g., based on GPS data), trip date, trip time (e.g., session start time, end time, or midpoint), and driving score (indicated by a bar graph and numerical value). In addition to or instead of displaying the driving score for each session, screen 70c may display one or more driving behavior metrics for each session, and/or other data relevant to each session (e.g., weather conditions, traffic conditions, trip distance, trip duration, etc.). Any number of sessions may be displayed, and the particular sessions that are displayed may be filtered, e.g., according to any of the criteria discussed above. In the illustrated example, the user may scroll down on screen 70c to view data for additional sessions.

FIG. 5D illustrates an example screenshot of a summary screen 70d for a group of multiple data collection sessions, including three multi-session driving behavior metrics (Acceleration, Braking, and Cornering) and a multi-session driving score (“78”) calculated by data processing module 46b for the group of data collection sessions. Each multi-session driving behavior metric, as well as the driving score, for the group of sessions may be calculated based on any number of data collection sessions, and using any suitable algorithm. For example, each multi-session metric/score may be an average (e.g., straight or weighted average) of the respective metrics/scores determined for the n most recent data collection sessions. Further, the multi-session metric/score may be filtered according to preset or user-selected criteria. For example, each multi-session metric/score may be an average (e.g., straight or weighted average) of the respective metrics/scores determined for the n most recent data collection sessions that meet one or more preset or user-selected criteria regarding the respective data collection session, e.g., the particular driver, time of day, trip distance, trip duration, geographic area of travel, weather conditions, traffic conditions, or any other relevant data accessible to data processing module 46b. Thus, for instance, module 46b may calculate multi-session driving behavior metrics and driving scores for the five most recent trips, which were further than 3 miles, within the geographic limits of a particular city, and during good weather conditions.

In embodiments in which particular multi-session driving metrics/scores represent weighted averages, each individual-session metric (e.g., each individual-session Braking metric) to be averaged into a weighted average may be weighted based on recentness (e.g., based on the elapsed time since that session, or the sequential order position of that session (e.g., the 3^{rd} most recent session)), trip duration, trip distance, or any other relevant criteria accessible to data processing module 46b. Thus, for instance, the weighting of each individual-session metric to be averaged into a weighted average may be weighted proportionally according to the number of days since each respective session, such that a trip that occurred 20 days ago is weighted twice as much as a trip that occurred 20 days ago. As another example, the 1^{st} most recent, 2^{nd} most recent, 3^{rd} most recent, and 4^{th} most recent sessions may be assigned predefined weighting factors of 0.50, 0.30, 0.15, 0.05, respectively. As another example, a 6-mile trip may be weighted the same as, or twice as much, as a 3-mile trip, depending on the specific embodiment. As another example, a 30-minute trip may be weighted the same as, or three times as much, a 10-minute trip, depending on the specific embodiment.

Alternatively, instead of displaying the average of the metrics/scores determined for a group of data collection sessions, summary screen 70d may display the median value for particular metrics/scores. Thus, for example, summary screen 70d may display for each metric the median value for that metric over the last seven trips. As another alternative, summary screen 70d may display the lowest or highest value for particular metrics/scores. Thus, for example, summary screen 70d may display for each metric the lowest value for that metric over the last seven trips.

It should be understood that multi-session driving metrics/scores may be determined using any combination of techniques or algorithms discussed above, or using any other suitable techniques or algorithms.

FIG. 5E is a drawing illustrating example mobile device 10 showing a display screen 70e that might provide a suggested vehicle to a driver or one or more pieces of equipment for the driver's vehicle of choice (e.g., a currently owned vehicle), according to teachings of the present disclosure. For example, in response to a suggestion request from a driver, driving performance application 44 may identify one or more suggested types of vehicle based on various safety criteria, as described above. In the example screen 70e shown in FIG. 5E, one suggested vehicle may be displayed to a driver as a list of vehicles with high safety ratings for the most frequent routes, type of driving, and/or driving performance profile of the driver. In some embodiments, various vehicle equipment may be identified by a safety level designation (e.g., good, fair, poor, and/or severe).

It should be understood that driving performance application 44 may generate any number of additional screens for displaying the various information collected, transmitted to, or processed by application 44.

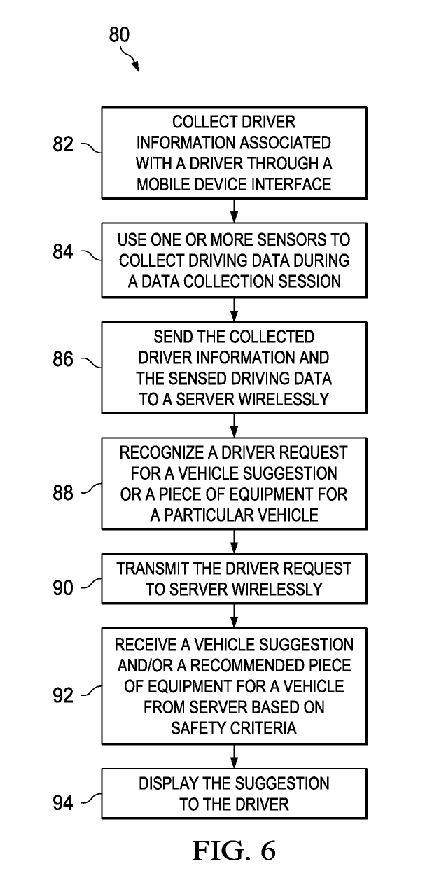

FIG. 6 is a flowchart illustrating an example method 80 for providing a suggestion for a vehicle or a piece of vehicle equipment. Method 80 may be executed by mobile device 10, in conjunction with server 22. Mobile device 10 may be in communication with one or more sensors associated with vehicle 12. The one or more sensors may collect driving information data during a data collection session. Mobile device 10 may execute driving performance application 44 and communicate wirelessly with server 22.

At step 82, mobile device 10 may collect driver information associated with a driver through a mobile device interface, such as data collection module 46a of route information application 44. In some embodiments, data collection module 46a may access driver data from additional sources, such as data saved on server 22 and/or any data available to mobile device 10 internet sources, etc.).

At step 84, mobile device 10 may use one or more sensors associated with vehicle 12 to collect driving data during a data collection session. The one or more sensors may include, for example, GPS data, accelerometers, etc.

At step 86, mobile device 10 may send the collected driver information and the sensed driving data to server 22 wirelessly. Mobile device 10 may perform step 86 any number of times, including every time the driver drives vehicle 12 with mobile device 10 present. In some embodiments, mobile device may calculate, based at least on the collected driving data, one or more metrics related to the driver's driving behavior and transmit the one or more calculated metrics related to the driver's driving behavior to server 22 wirelessly. In other embodiments, server 22 may perform the calculations based on raw data received from mobile device 10 and/or driving performance application 44.

At step 88, mobile device 10 may recognize a driver request for a vehicle suggestion or a piece of equipment for a particular vehicle. The driver request may include a voice-activated request, typing text into mobile device 10 for use by driving performance application 44, and/or any other appropriate method to receive data from a user.

At step 90, mobile device 10 may transmit the driver request to server 22 wirelessly. Mobile device 10 may be in communication with server 22 by any appropriate avenue of communication.

At step 92, mobile device 10 may receive a vehicle suggestion and/or a recommended piece of equipment for a vehicle from server 22 based on safety criteria. In some embodiments, the suggestion is determined by applying safety criteria to a plurality of vehicle options and identifying the suggestion based at least in part on one or more calculated metrics based on the driving data related to the driver's driving behavior.

At step 94, mobile device 10 may display the suggestion to the driver through display 36. As discussed with respect to example screen 70e shown in FIG. 5E, the suggested route may be displayed to a driver as a map, with various features of interest. In some embodiments, various route segments may be labelled and/or identified by a safety level designation (e.g., good, fair, poor, and/or severe). In some embodiments, driving performance application 44 may identify a specific vehicle by make and model or a type/class of vehicle without a specific brand. The instructions may be provided as a text list and/or by audio.

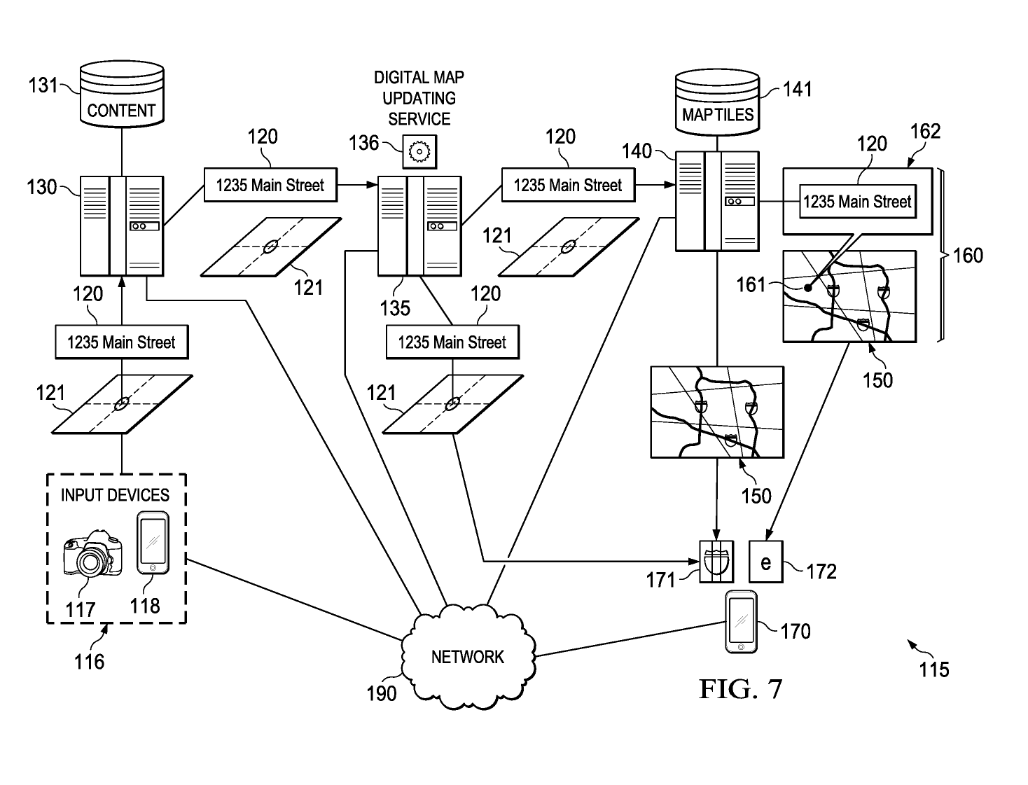

FIG. 7 is a schematic drawing illustrating an example system 115 which may be used to implement teachings of the present disclosure. System 115 may include user input devices 116, a host server 130 for hosting content, an update server 135 for updating content, a user server 140 and one or more user mobile devices 170. The various components of system 115 may be in communication over network 190. Although the various servers are shown as discrete computing systems and/or devices, persons having ordinary skill in the art will be able to implement the various functions described on virtual server, partitions, modules, etc. whether located in a single physical component or distributed across multiple components. System 115 may provide a platform for providing vehicle suggestions according to various teachings of the present disclosure to the one or more user mobile devices 170.

System 115 may receive data 120 from user input devices 116 as described above, related to driving scores, measured driving data, etc. Received data 120 may be “geo-tagged”, which means the data is associated with location data provided by Global Positioning System (GPS) hardware associated with user input devices 116. Received data 120 may be represented in FIG. 7 as numerical data, but may include graphical data, images, and/or any other data useful to assess the relative safety and/or complexity of a given route segment, the vehicle in use, and/or current context data.

In some embodiments of system 115, received data 120 may be sent by user input devices 116 at host server 130 over network 190. Host server 130 may provide notice to update server 135. Update server 135 may run one or more update modules 136 operable to update maps, data libraries, etc. to reflect received data 120. Various update modules 136 may be associated with various geographical areas, certain types of data, etc.

Update module 136 may provide the updated information to user server 140. Update module 136 may provide data indicating which maps and/or data are to be replaced. In some embodiments, update module 136 may direct user server 140 to replace outdated maps and/or other data. In other embodiments, update module 136 may direct user server 140 to add the new data to the existing maps and/or other data without replacing them.

A user and/or a driver requesting a suggestion via a mobile device 170 may receive one or more suggestions from user server 140. In some embodiments, driving performance application 44 may be running on mobile device 170. Driving performance application 44 may submit a request over network 190, over the Internet, and/or any other available communication channel. Driving performance application 44 may display the suggestion on mobile device 170 as discussed above with respect to mobile device 10.

Although the disclosed embodiments are described in detail in the present disclosure, it should be understood that various changes, substitutions and alterations can be made to the embodiments without departing from their spirit and scope.

What is claimed is:

1. A method for providing vehicle or equipment suggestions, the method comprising:
providing a driving performance application to a driver for installation on a mobile device;
collecting driver data at a remote server, the driver data transmitted by the mobile device through the driving performance application to the server;
the server comprising a processor and a memory that stores the driver data, wherein the server:
receives driving data associated with a plurality of drivers and routes, the driving data including context dependent route information;
compiles the received driving data with context dependent route information;
analyzes the compiled driving data to determine a suggestion for a vehicle or piece of vehicle equipment for the driver based on safety criteria;
generates a notice that the suggestion is available for access by the driver; and
transmits the notice to the mobile device based upon a transmission schedule,
wherein the transmitted notice activates the driving performance application to make the suggestion available to the driver.

2. A method according to claim 1, wherein the server further analyzes the compiled driving data in light of the collected driver data.

3. A method according to claim 1, wherein the context dependent route information includes traffic levels.

4. A method according to claim 1, wherein the context dependent route information includes weather data.

5. A method according to claim 1, wherein the safety criteria include weather conditions experienced by the driver.

6. A method according to claim 1, wherein the compiled driving data include driver performance scores calculated for similar drivers in similar driving conditions.

7. A method according to claim 1, further comprising offering the driver an adjusted rate premium for motor vehicle insurance based on whether the driver adopts the suggestion.

8. A system for providing vehicle or equipment suggestions, the system comprising:
one or more sensors associated with a motor vehicle and configured to collect driving data during a data collection session;
a mobile device in communication with the one or more sensors, running a driving performance application, and equipped to communicate wirelessly with a remote server;
the remote server comprising a processor and a memory that stores a set of computer readable instructions stored in the memory and when executed by the processor configured to:
calculate one or more metrics related to the driver's driving behavior, based at least on the collected driving data;
compile the one or more calculated metrics related to the driver's driving behavior with a plurality of calculated metrics related to other drivers' driving behavior;
analyze the compiled calculated metrics to determine a suggested vehicle or piece of vehicle equipment based on safety criteria; and
transmit the suggestion to the driving performance application for display using the mobile device.

9. A system according to claim 8, wherein the processor determines the suggested vehicle or piece of vehicle equipment by applying safety criteria to a plurality of driving performance metrics measured over various driving routes and identifying the suggested vehicle or piece of vehicle equipment based at least in part on the metrics related to the driver's driving behavior.

10. A system according to claim 8, wherein the set of computer readable instructions stored in the non-transitory storage medium, when executed by the processor, are configured to:
collect the driving data during multiple separate data collection sessions, each corresponding to a separate driving session;
combine the driving data collected during the multiple data collection sessions; and
calculate, based on the combined driving data collected during the multiple data collection sessions corresponding to multiple driving sessions, at least one metric related to the driver's driving behavior during the multiple driving sessions.

11. A system according to claim 8, wherein the set of computer readable instructions stored in the non-transitory storage medium, when executed by the processor, are configured to:
calculate, based on the combined driving data collected during the multiple data collection sessions corresponding to multiple driving sessions, an averaged value of a particular metric for the multiple driving sessions; and
use the averaged value of the particular metric for the multiple driving sessions when identifying the suggested vehicle or piece of vehicle equipment.

12. A system according to claim 8, wherein the one or more sensors associated with the vehicle comprises an accelerometer, and wherein the set of computer readable instructions, when executed by the processor, calculate one or more metrics related to the driver's driving behavior, the metrics being at least one of:
an acceleration metric indicative of the vehicle acceleration;
a braking metric indicative of the vehicle braking; and
a cornering metric indicative of the vehicle cornering.

13. A system according to claim 8, wherein the set of computer readable instructions, when executed by the processor:
calculate multiple individual metrics related to the driver's driving behavior;
calculate an overall score based on the multiple different metrics;
use the calculated overall score to determine the suggested vehicle or piece of vehicle equipment.

14. A system according to claim 8, wherein the set of computer readable instructions stored in the non-transitory storage medium, analyze the collected driving data to identify notable driving events occurring during the data collection session.

15. A system according to claim 8, wherein the set of computer readable instructions stored in the non-transitory storage medium, when executed by the processor, analyze the collected driving data to identify notable driving events occurring during the data collection session by:
comparing driving data collected during particular events within the data collection session with one or more predefined thresholds; and
identifying the presence of notable driving events based on the comparisons.

16. A non-transitory computer readable medium with computer executable instructions stored thereon executed by a processor to perform a method for providing a suggested vehicle or piece of vehicle equipment, the method comprising:
collecting driver information associated with a driver through a mobile device interface;
using one or more sensors associated with a vehicle to collect driving data during a data collection session;
sending the collected driver information and the sensed driving data to a server wirelessly; and
receiving a suggested vehicle or piece of vehicle equipment from the server.

17. A non-transitory computer readable medium according to claim 16, the method further comprising:
calculating, based at least on the collected driving data, one or more metrics related to the driver's driving behavior; and
transmitting the one or more calculated metrics related to the driver's driving behavior to the server wirelessly.

18. A non-transitory computer readable medium according to claim 16, the method further comprising:
automatically collecting the driving data during multiple separate data collection sessions, each corresponding to a separate driving session;
calculating, based on driving data collected during an individual data collection session corresponding to an individual driving session, at least one metric related to the driver's driving behavior during the individual driving session; and
transmitting the at least one calculated metric related to the driver's driving behavior to the server wirelessly.

19. A non-transitory computer readable medium according to claim 16, the method further comprising:
collecting the driving data during multiple separate data collection sessions, each corresponding to a separate driving session;
combining the driving data collected during the multiple data collection sessions; and
calculating, based on the combined driving data collected during the multiple data collection sessions corresponding to multiple driving sessions, at least one metric related to the driver's driving behavior during the multiple driving sessions.

20. A non-transitory computer readable medium according to claim 16, wherein the preferred driving route is determined by applying safety criteria to a plurality of potential driving routes and identifying the preferred driving route based at least in part on one or more calculated metrics based on the driving data related to the driver's driving behavior.
